(19) United States
(12) Patent Application Publication
(10) Pub. No.: US 2007/0055567 A1
(43) Pub. Date: Mar. 8, 2007

(54) Donation mechanism

(75) Inventor: Minna Viitaharju, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/399,784

(22) Filed: Apr. 7, 2006

(30) Foreign Application Priority Data
Aug. 22, 2005 (FI) 20055441

(51) Int. Cl. G06Q 30/00; G06F 15/16

(52) U.S. Cl. 705/14; 709/206

(57) ABSTRACT

A method and apparatus for effecting and controlling associated transactions, wherein crediting a third party is confirmed on submitting content to a predetermined recipient on selection of the submitter. The content is sent as a short message, multimedia message or e-mail and the associated transaction involves charging the submitter's telecommunications account with an Accounting, Authentication and Authorisation server to credit the third party.

### FIELD OF THE INVENTION

The present invention generally relates to donating with electronic communications. The invention relates, in particular but not exclusively, to crediting a chosen charity using a telecommunication network's Accounting, Authentication and Authorisation (AAA) server on submitting a message to a friend, relative or colleague.

### BACKGROUND OF THE INVENTION

Charity organisations operate often with voluntary staff, but nevertheless need plain money to address certain situations such as catastrophes and helping ill and/or poor people, among others. Such organisations often issue their own greeting cards for special events such as New Year's. It is also becoming more common to replace small business gifts with a donation to the charity and a card expressing that a donation has been made for the recipient. Perhaps even more common is the sending of cardboard based cards printed with a charity organization logo and text for the Red Cross®, WWF® and the like. The charity gains a small amount of money per each card purchased for the use.

The internet is quickly spreading to homes in developed countries and thereby gives rise to a number of electronic systems where a donation can be made by sending electronic greetings. Such systems typically provide for voluntary credit to the charity or expose users to advertisements so that the site providing the donation service can utilize advertisers for accessing the donors. Some mobile telephone operators also support charities by donating a predetermined portion of their income. Such a method may ease the donating and help the charity, but, however, suffers from a given inflexibility: a user may not choose whom to aid and when, and the user cannot share her good spirits with a friend or business contact in a discreet and acceptable manner.

It is desired to provide new alternatives to carrying out donations and other crediting in general to desired parties. It is also desirable to enable capturing an ever-growing portion of people who donate to charities.

### SUMMARY OF THE INVENTION

According to a first aspect of the invention there is provided a method in a network apparatus serving subscribers of a telecommunications network, including:
identifying a charity message from a plurality of messages;
identifying a message recipient of the message;
identifying an associated donation recipient;
instructing an account server to transfer a donation to the associated donation recipient; and
passing the charity message towards the message recipient with a notice of a donation being made.

Advantageously, a mobile telecommunications subscriber, for instance, may send a donation message to a message recipient and also donate to a desired donation recipient so that the message recipient will perceive the donation.

The method may further include identifying the associated donation recipient to the recipient of the message. The identification may take place by correspondingly modifying the message to contain a coded or plain identification of the associated donation recipient. Advantageously, by modifying the message in the network apparatus, there is no need for a sender to enter and send any explanation of a charity donation being made and telecommunications resources can be spared on a link between the sender and the network apparatus.

The identification of the charity message may be based on an identifier associated with the message. The identifier may reside within the message, for instance, at the start or end of the message or at a message header or the identifier may be provided by signalling related to the message. By providing the identifier within the message existing messaging clients may be used as is or with little modification to produce charity messages compliant with the first aspect.

The identification of the charity message may be based on a proxy address associated with the charity message. The network apparatus may recognize all messages sent to the proxy address as charity messages and identify the final recipient of the charity message from the content of the charity message or from other associated signalling. The method may further involve identifying the associated donation recipient based on the proxy address so that different proxy addresses correspond to different charity parties. Advantageously, using the proxy address to identify the desired donation recipient enables technically robust identification of charity messages as the network apparatus may use existing registers of telecommunications networks to distinguish charity messages from other messages.

The passing of the message towards the recipient may be subject to a successful instruction of the account server to transfer the donation to the donation recipient or to a successful transfer itself. Alternatively, the passing of the message may be independent of the success of the transfer. However, modifying the message may be conditional on the success of the transfer so that the message itself is always passed to the recipient, but only on a successful making of the donation the message is modified accordingly to advise the recipient of a donation made for him or her.

Advantageously, in the case of charities, it is unlikely that many messages will be sent without sufficient payment capability of the sender. Hence, it may suffice to simply instruct the accounting server, as regardless the charity organization in question will be positively mentioned to the recipient so that new transaction opportunities may follow.

The message may carry a message modifier flag for indicating whether to modify the donation message with the donation identifier. The donation identifier may be included if the sender opts in or does not opt out of this modification.

Advantageously, the sender or donor may choose not to send donation messages so that the recipient will not be informed of the associated donation. This may be convenient if the sender does not wish to highlight the donation for any reason, such as political correctness.

The donation recipient identifier may identify the donation recipient uniquely or relative to the donor. In a relative identification, the network entity may make use of the donor's subscriber number, location, nationality and/or pre-stored preferences in identifying the donation recipient in question. Alternatively, the network element may simply pass the donation identifier to the accounting server for a corresponding determination of the donation recipient therein. Further alternatively, the donation recipient identifier may identify the donation recipient by a class of recipients, such as for catastrophe relief, domestic poverty relief, domestic health support, etc. It may then be the responsibility of the operator of the network apparatus to direct the donation to a suitable party or parties in accordance with the class.

The charity message may be a message of a commercial telecommunications network operated by a telecommunications operator and thus subject to charging by the operator with the accounting server. Advantageously, the telecommunications network is a wireless telecommunications network, such as a cellular or satellite network. Wireless networks typically provide for reliable authentication and authorization, as required for processing financial transactions, and use personal equipment that is common and accessible all day long.

According to a second aspect of the invention there is provided a network apparatus for serving subscribers of a telecommunications network, including:
means for identifying a charity message from a plurality of messages;
means for identifying a message recipient of the message;
means for identifying an associated donation recipient;
means for instructing an account server to transfer a donation to the donation recipient; and
means for passing the charity message towards the message recipient with a notice of a donation being made.

According to a third aspect of the invention there is provided a charity message including:
a type identifier for identifying the charity message among a plurality of messages;
a recipient identifier for identifying a recipient of the charity message;
a donation receiver identifier for identifying an intended receiver of a donation; and
a user message.

According to a fourth aspect of the invention, there is provided a system including a network apparatus for serving subscribers of a telecommunications network and a client, the network apparatus including: means for identifying a charity message from a plurality of messages; means for identifying a message recipient of the charity message; means for identifying a donation recipient; means for instructing an account server to transfer a donation to the donation recipient; and means for passing the charity message towards the message recipient with a notice of a donation being made; the client including: means for a user to compose a message; means for associating a type identifier with the message for identifying the message among a plurality of messages as a charity message; means for addressing the message to the response recipient with a respective recipient identifier; and means for associating a donation receiver identifier for identifying an intended receiver of a donation. The system may further include an account server for providing accounting services for a telecommunications network operator and for charging the donation from the sender under the instruction of the network apparatus.

Various embodiments of the present invention have been illustrated only with reference to certain aspects of the invention. It should be appreciated that corresponding embodiments may apply to other aspects as well.

### BRIEF DESCRIPTION OF THE DRAWINGS

The invention will now be described, by way of example only, with reference to the accompanying drawings, in which:

FIG. 1 presents a simplified block diagram of a system according to an exemplary embodiment of the invention;

FIG. 2 presents a simplified block diagram of a Transaction Server (TS) shown in FIG. 1;

FIG. 3 presents a simplified block diagram of a Composing Mobile Station shown in FIG. 1;

FIG. 4 presents a simplified block diagram of an alternative embodiment of the TS;

FIG. 5 presents a simplified flow chart of the operation of the TS of FIG. 2;

FIG. 6 presents a simplified flow chart of the operation of the alternative TS of FIG. 4;

FIG. 7 presents a message according to an exemplary embodiment of the invention; and

FIG. 8 presents a message according to another exemplary embodiment of the invention.

### DETAILED DESCRIPTION

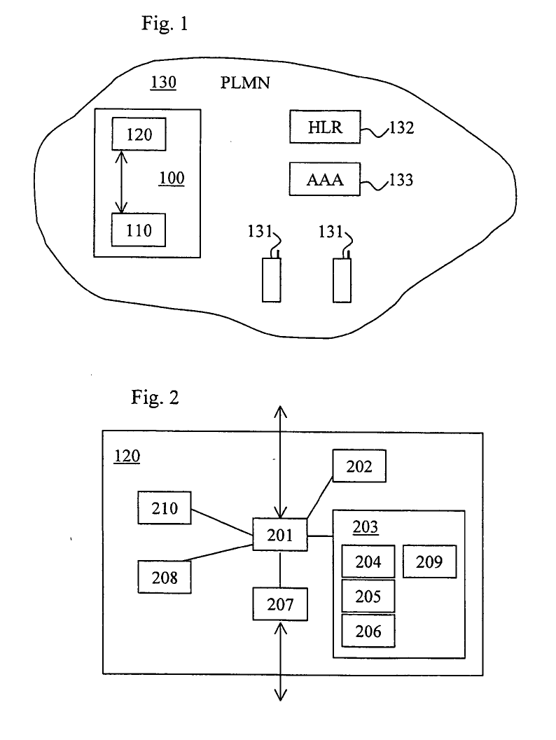

FIG. 1 presents a simplified block diagram of a system 100 according to an exemplary embodiment of the invention. The system 100 is built on any Public Land Mobile Network (PLMN) such as cellular networks GSM and CDMA, or on a satellite, landline or Internet-based telephone system. Popular cellular networks are advantageous for their large existing user base and for their typically sophisticated authentication, accounting and authorization (AAA) functions run by common or dedicated servers.

The system 100 includes a Composing Mobile Station (C-MS) 110 and a transaction server (TS) 120 operable within a PLMN 130 including a plurality of Mobile Stations (MS) 131. The C-MS 110 is also a subscriber of the PLMN 130, but here shown distinguished from others for illustration only. The PLMN 130 further includes a Home Location Register (HLR) 132 and an AAA server 133 located functionally close to the HLR 132 for functions of the PLMN.

The TS 120 is accessible by the C-MS 110 and is capable of transmitting messages to mobile stations 131 by their subscriber identifications via the PLMN 130.

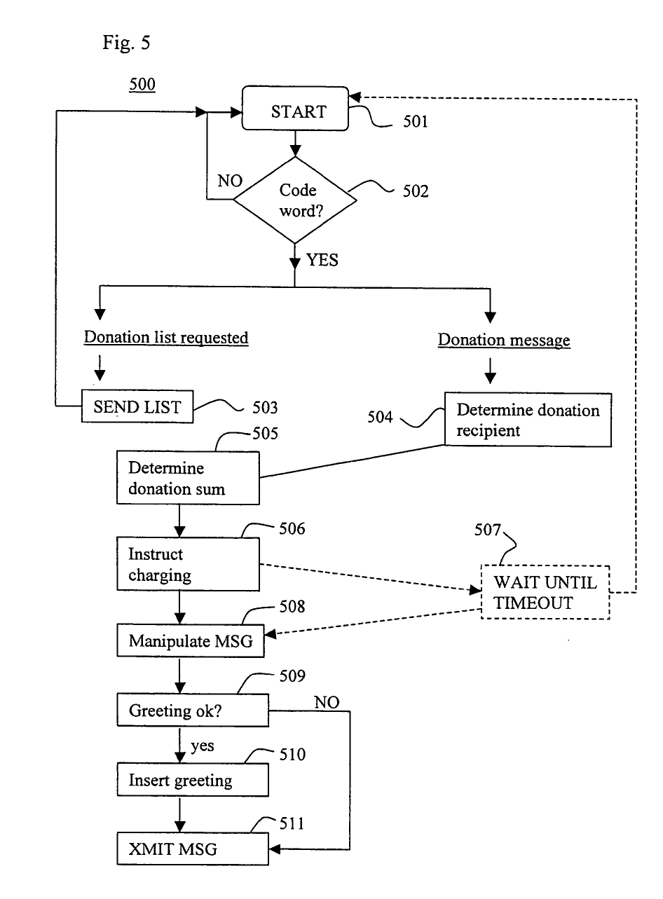

The TS 120 is typically embedded in the PLMN 130 so that an A-subscriber number, that is, a number of the C-MS 110, is readily available to the TS 120. Hence, the TS 120 can rely on the AAA function of the PLMN 130. Alternatively, the TS 120 has no access to reliable AAA functions of the PLMN 130 and the C-MS 110 is unreliably identified by a message supposedly composed by the C-MS 110. In this case, a separate authorization is obtained by sending a verification message from the TS 120 to the C-MS 110 and waiting for a positive acknowledgment (ACK) before proceeding. The TS obtains the identity of the intended recipient of each message it processes from the content of the message itself. Other elements or entities of the PLMN 130, accessible to the TS 120, may participate in processing the contents of the messages. The TS 120 may receive pre-filtered recipient number(s) either separately or together with the message. This may be particularly useful if the pre-filtering is carried out by a server with access to subscriber phone books so that the existence of the recipient number can be first verified. Armed with the recipient number and the C-MS number, the TS 120 can effect a donation and pass on a potentially modified message to the recipient as will be described in more detail with reference to FIGS. 4 and 5.

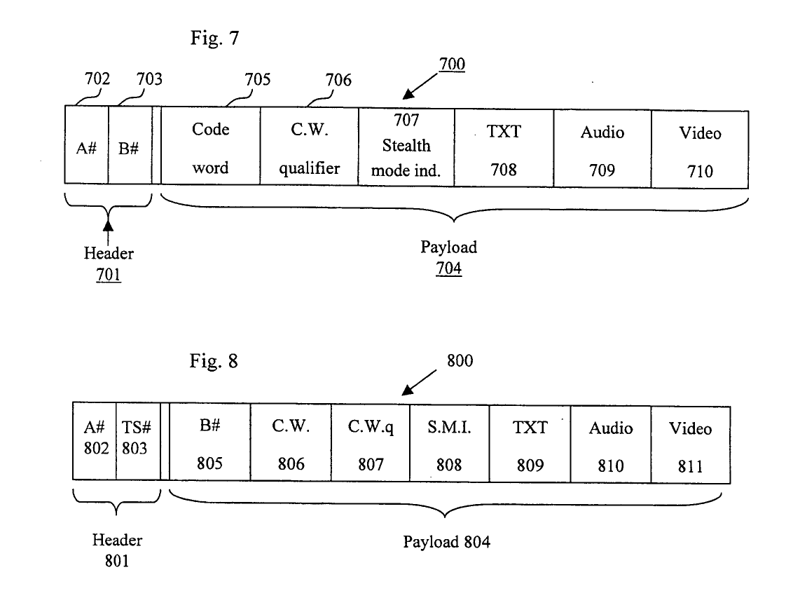

FIG. 2 presents a simplified block diagram of the TS 120 shown in FIG. 1. In this embodiment, the TS 120 is incorporated into the equipment of the PLMN 130 that normally handles messages of a given type, such as short messages (SMS), Multimedia Messaging Service (MMS) or e-mail. The TS 120 searches for specific messages (see FIG. 7) that contain one or more predetermined strings in the message body and/or header. The predetermined strings identify a message as a donation message and triggers a donation process with the TS 120 as further described with reference to FIG. 5. The TS 120 includes a message processor 201 for performing normal processing related to message delivery, such as delivering and charging in cooperation with the AAA server 133. The TS 120 further includes a message searcher 202 for searching messages for the predetermined strings and a memory 203 for storing computer program code 204 for controlling the message searcher 202. The memory 203 additionally stores a first database 205 containing the predetermined strings which identify donation messages and a second database 206 containing data of various donation recipients associated with the predetermined strings. The second database 206 may also contain predefined donation amounts associated with the predetermined strings such that by a given code, a preset donation will be effected to a predefined party or donation recipient. Further, the second database 206 may include dedicated greetings for each or selected donation recipients for embedding into a message before transferring the message to the message recipient. The computer program code 204 controls the operation of the TS 120. In an alternate embodiment, the two databases 205, 206 may be consolidated. In another alternate embodiment, the first database 205 may be replaced by a rule or by a rule set according to which the predetermined strings are formed. As a non-limited example, an autocorrelation function may be run on the message to check for the existence of the specific code such that the position of the string within the message can be freely chosen.

The TS 120 further includes an accounting instructor 207 configured to instruct the AAA server 133 to credit the donation recipient a desired amount as identified by the message searcher 202. The network operator running the AAA server 133 need not charge for the donation transaction since the sending of the message in itself incurs charging and is likely to invoke further messaging if there appear to be no additional expenses. Alternatively, the AAA server 133 may charge the subscriber of the C-MS 110 for effecting the donation.

The TS 120 further includes a message manipulator 208 for removing the specific string from the message and/or for embedding an automated greeting in the message before passing the message to the message recipient. The embedding of the greeting may be subject to a choice of the sender. The message manipulator 208 may also be capable of stealth mode operation in which no greeting is inserted and the predetermined string is removed such that except for possible disclosure in the message of the sender, the recipient will receive no automatic or further indication of the donation in the message delivered to him or her. To this end, the memory 203 may store a sender profile database 209 and/or stealth mode code to be utilized by the message searcher 202 for message-specific determination of stealth mode operation.

It can be appreciated that in this exemplary embodiment, messages of arbitrary format can be composed and sent to anyone so that the presence of a predetermined string or code causes a donation to be made. Hence, no special properties are required of the C-MS 110 to compose a special message.

In addition to the features described in the foregoing, the TS 120 may further include a donation list provider block 210 capable of sending a donation list in response to a message requesting such a list with an associated code string identifiable by the message searcher 202. In this case, a further string such as “donation list” should be defined in the memory 203 and the computer program code 204. Alternatively, the additional code string may be provided by separate advertising campaigns and/or be intuitively derivable such that they are easy to remember or deduce, such as an example code string “donatemms:wwf”, wherein the initial part of the string identifies a command to donate and the latter part identifies a donation recipient. The latter part need not explicitly identify the donation recipient but may simply refer to a general cause, such as “nature” or “poor”, in which case the TS 120 would select suitable donation recipients that are profiled in working with the respective general cause.

Each of the functional blocks (message processor 201, message searcher 202, accounting instructor 207, message manipulator 208 and donation list provider block 210) can be implemented by the computer program code 204. The computer program code 204 need not consist of a unitary set of instructions. Instead, the computer program code 204 may contain a number of separate programs executable in one or more computer languages.

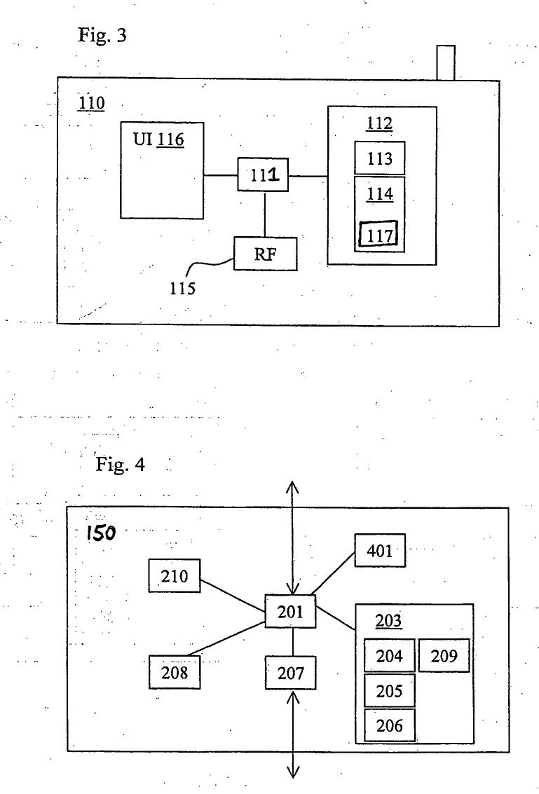

FIG. 3 presents a simplified block diagram of the Composing Mobile Station (C-MS) 110 shown in FIG. 1. The C-MS 110 includes a processor 111, a memory 112 including a working memory 113 and a non-volatile memory 114, a Radio Frequency (RF) block 115, and a user interface (UI) 116.

The processor 111 is typically a microprocessor or Digital Signal Processor. The working memory 113 typically contains Random Access Memory or flash-RAM. The non-volatile memory 114 typically contains Read Only Memory, mass memory, or flash-RAM. The non-volatile memory 114 contains computer executable program code 117 for controlling the processor 111 to run the C-MS110 in the desired manner. The UI 116 includes keys, typically in the form of a keyboard or keypad, a display, and audio equipment for audio signal input and/or output.

The processor 111 controls the C-MS 110 to operate in accordance with the invention. The hardware, or any non-software blocks of C-MS 110, are similar to those in prior art, but controlled by computer program code 117 in order to implement the invention.

FIG. 4 presents a simplified block diagram of an alternative embodiment of the TS 150. Unlike the previous embodiment with a message searcher checking all messages, in this exemplary embodiment the messages are addressed to the donation server and the recipient number or other identification is contained in the message. Hence, the message searcher is replaced with a message recipient searcher 401 that obtains the recipient number either directly from the message content or indirectly by using a phone book server to determine the recipient number if only the name and address are provided instead of the number, as a non-limiting example. In other respects, the TS 150 is substantially equivalent with that the TS 120 shown in FIG. 2.

FIG. 5 presents a simplified flow chart of the operation 500 of the TS 120 of FIG. 2. In start box 501, the TS 120 is ready to receive messages. On arrival of a new message, the TS 120 checks in step 502 whether that message contains a code word or string that identifies a special message. If yes, the operation branches depending on the special message. If the code word identifies a request for a donation list, the TS 120, in step 503, sends back a list of different donation parties typically, though not necessarily, with respective donation amounts. If the code word identifies a donation message, the TS 120 determines the donation recipient in step 504, determines the amount of the donation in step 505, and instructs the AAA server 133 to carry out a respective transfer to the donation recipient in step 506. Next, in step 507 the TS 120 optionally waits for a confirmation until a possible timeout that ends the process in the absence of a confirmation of a successful transfer, or the TS 120 proceeds directly to step 508 to manipulate the message. In step 508, the message is manipulated by removing the code word or string including possible qualifiers thereof (such as the sum to be donated). In step 509, the TS 120 checks whether a greeting is allowed and, if so, the greeting is inserted in the message in step 510. The message is next transmitted to the message recipient in step 511 as normal messages are forwarded by the TS 120.

As the TS 120 can run thousands or more of the processes 500 simultaneously, the operation 500 was drawn for one single message. The process 500 expires at the end of a single chain of steps. The next message invokes the process 500 again. It is also quite feasible to distribute the operation of the TS 120, for instance, by using a pre-screening server to filter out the messages with the predetermined string and to divert such messages to respective service providers for the message manipulation and charging.

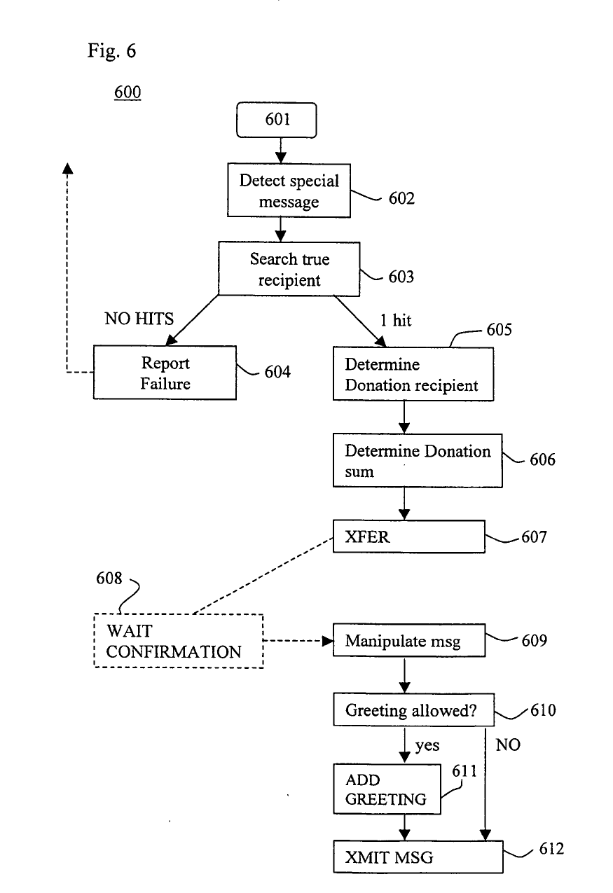

FIG. 6 presents a simplified flow chart of the operation 600 of the alternative TS 150 of FIG. 4. As with FIG. 5, this operation concerns one message only. The TS 150 receives a message in step 601 and detects the message as a special message in step 602, based on the recipient number (if possible). The TS 150 next searches the message for a true message recipient number in step 603. If no unambiguous hit is found, the TS 150, in step 604, reports a failure and its reason to the C-MS 110, possibly with an option to reply with just the missing true recipient number. Once the TS 150 possesses the true recipient number, the TS 150 removes the true message recipient number from the message. The TS 150 next determines the donation recipient, in step 605 either from the originally used recipient number or from a respective string in the message, determines the amount of donation in step 606, and instructs the AAA server 133 to carry out a respective transfer to the donation recipient in step 607. Next, in step 608, the TS 150 optionally waits for a confirmation until a possible timeout that ends the process in the absence of a confirmation of a successful transfer, or the TS 150 proceeds directly to step 609 to manipulate the message. In step 609, the message is manipulated by removing any code word or string including possible qualifiers thereof (such as the sum to be donated). In step 610, the TS 150 checks whether a greeting is allowed and, if so, the greeting is inserted in step 611. The manipulated message is next transmitted to the message recipient in step 612.

The manipulation of the message, both with reference to FIGS. 5 and 6, may involve inserting a frame or logo associated with the donation receiver into the message so that the donation receiver is perceivable in an elegant manner.

FIG. 7 presents a message 700 on the way to the TS 120 according to an exemplary embodiment of the invention. The message 700 includes a header 701 including a sender field (A-subscriber) 702 and a recipient field (B-subscriber) 703. The message 700 further includes a payload 704. The payload 704 includes a code word 705, a code word qualifier 706 that is a number showing the sum of the donation, an optional (positive or negative i.e. opt-in or opt-out) stealth mode indicator 707, and an additional message for the one or more message recipients. The message 700 optionally includes a text field 708, an audio content field 709 and/or a video content field 710.

FIG. 8 presents a message 800 on the way to the alternative TS 150 of FIG. 4 according to another exemplary embodiment of the invention. The message 800 includes a header 801 including a sender field (A-subscriber) 802 and a recipient field 803. The message 800 further includes a payload 804. The recipient field 803 does not contain the B-subscriber number but rather a number for a donation server or TS 150. The payload 804 includes a number of the B-subscriber 805 and one or more of the following: a code word 806, a code word qualifier 807 that is a number showing the sum of the donation, and a stealth mode indicator 808. The payload typically contains an actual message for one or more message recipients, possibly including one or more text fields 809, audio content fields 810 and/or video content fields 811. The code word 806 can be omitted, especially if the recipient field 803 readily identifies the donation recipient or if the sender does not wish to expressly define a particular donation recipient. Also the code word qualifier 807 may be omitted if predetermined amounts are used.

The message 700,800 may be created by any terminal, though alternatively the C-MS 110 can be specially adapted by means of suitable program code, as a non-limiting example, to query the desired donation receiver and donation amount, to fill in the necessary information, and/or to send to the correct number (in the case of the alternatively embodied TS 150). In order to facilitate the entry of messages, the mobile stations 110 and 131 may contain pre-defined message templates as known from the Nokia® 6800 GSM telephone. Such templates can be used to facilitate composition of the donation messages as well as possible responses to send thanks for a received donation message. Particularly, templates designed for acknowledging a received donation message are likely to increase messaging, which is advantageous to cellular operators.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like), may be transmitted to a semiconductor fabrication facility or “fab” for fabrication.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As a non-limiting example, a sender may be rewarded for making donations and sending charity messages by allowing him or her to send some messages free of any additional charges after having sent a given number of chargeable messages. As an additional non-limiting example, a sender may similarly be rewarded with a free screen saver, wall paper or ring tone. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the present invention, and not in limitation thereof.

1. A network apparatus for serving subscribers of a telecommunications network, including:
means for identifying a charity message from a plurality of messages;
means for identifying a message recipient of the charity message;
means for identifying a donation recipient;
means for instructing an account server to transfer a donation to the donation recipient; and
means for passing the charity message towards the message recipient with a notice of a donation being made.

2. A network apparatus according to claim 1, wherein the means for identifying a donation recipient includes one of detecting a coded identification of the donation recipient, detecting a plain identification of the donation recipient, or detecting a donation recipient identifier associated with the message.

3. A network apparatus according to claim 2, wherein the donation recipient identifier resides within one of the charity message, a message header, and signalling related to the message.

4. A network apparatus according to claim 1, wherein the means for identifying a charity message is configured to utilize a proxy address associated with the charity message, wherein different proxy addresses correspond to different donation recipients.

5. A network apparatus according to claim 2, wherein the means for identifying a charity message is configured to utilize a proxy address associated with the charity message, wherein different proxy addresses correspond to different donation recipients.

6. A network apparatus according to claim 1, further including means for obtaining a code word qualifier from the charity message, the code word qualifier including a sum of the donation, in order to correspondingly interact with the means for instructing the account server to transfer a donation based upon the code word qualifier.

7. A network apparatus according to claim 2, further including means for obtaining a code word qualifier from the charity message, the code word qualifier including a sum of the donation, in order to correspondingly interact with the means for instructing the account server to transfer a donation based upon the code word qualifier.

8. A method in a network apparatus serving subscribers of a telecommunications network, including:
identifying a charity message from a plurality of messages;
identifying a message recipient of the charity message;
identifying an associated donation recipient;
instructing an account server to transfer a donation to the associated donation recipient; and
passing the charity message towards the message recipient with a notice of a donation being made.

9. A method according to claim 8, further including identifying the associated donation recipient to the message recipient.

10. A method according to claim 8 wherein the passing of the charity message towards the message recipient is subject to one of a successful instructing of the account server to transfer the donation to the donation recipient and a successful transfer itself.

11. A method according to claim 9 wherein the passing of the charity message towards the message recipient is subject to one of a successful instructing of the account server to transfer the donation to the donation recipient and a successful transfer itself.

12. A method according to claim 8, wherein the passing of the charity message is independent of a successful transfer.

13. A method according to claim 8, wherein the charity message carries a message modifier flag for indicating whether to modify the charity message with a donation identifier.

14. A method according to claim 8, wherein a donation recipient identifier identifies the associated donation recipient one of uniquely or relative to the donor.

15. A method according to claim 8, wherein the charity message is a message of a commercial telecommunications network operated by a telecommunications operator and subject to charging by the operator with the accounting server.

16. A method according to claim 8, further including obtaining a code word qualifier from the charity message, the code word qualifier including a sum of the donation, in order to correspondingly instruct the account server to transfer a donation based upon the code word qualifier.

17. A charity message including:
a type identifier for identifying a charity message among a plurality of messages;
a recipient identifier for identifying a recipient of the charity message;
a donation receiver identifier for identifying an intended receiver of a donation; and
a user message.

18. A charity message according to claim 17, wherein the charity message includes a header and a payload, wherein the donation receiver identifier is provided in the payload or the donation receiver identifier is identified by a proxy address of the charity message and a true address is indicated within the payload.

19. A charity message according to claim 17, wherein the user message is composed by a sender of the charity message.

20. A system including a network apparatus for serving subscribers of a telecommunications network and a client, the network apparatus including:
means for identifying a charity message from a plurality of messages;
means for identifying a message recipient of the charity message;
means for identifying a donation recipient;
means for instructing an account server to transfer a donation to the donation recipient; and
means for passing the charity message towards the message recipient with a notice of a donation being made;
the client including:
a message composer for allowing a user to compose a message;
means for associating a type identifier with the message for identifying the message among a plurality of messages as a charity message;
means for addressing the message to the message recipient with a respective recipient identifier; and
means for associating a donation receiver identifier for identifying an intended receiver of a donation.

21. A system according to claim 20, further including an account server for providing accounting services for a telecommunications network operator and for charging the donation to a sender under the instruction of the network apparatus.
